(19) United States
(12) Patent Application Publication
(10) Pub. No.: US 2024/0082088 A1
(43) Pub. Date: Mar. 14, 2024

(54) METHOD AND REMOVABLE ELECTRIC PROPULSION SYSTEM FOR A WHEELED OBJECT WITH A MEASURING MEANS AND A CONTROL MEANS

(71) Applicant: IFP Energies nouvelles, RUEIL-MALMAISON (FR)

(72) Inventors: Thierry LEPAGE, RUEIL-MALMAISON (FR); Stephane VENTURI, RUEIL-MALMAISON (FR); Bertrand LECOINTE, RUEIL-MALMAISON (FR)

(21) Appl. No.: 17/767,568

(22) PCT Filed: Oct. 13, 2020
(86) PCT No.: PCT/EP2020/078766

§ 371 Date: Apr. 8, 2022

(30) Foreign Application Priority Data
Oct. 23, 2019 (FR) FR1911852

(51) Int. Cl. A61G 7/08; A61G 5/04

(52) U.S. Cl. CPC A61G 7/08; A61G 5/047; A61G 2203/38

(57) ABSTRACT

The present invention relates to controlling a removable electric propulsion system for a rolling object. In this method, a signal representative of the torque at a wheel driven by an electric machine of the electric propulsion system is measured (MES). This measurement is compared (COMP), over different time increments, with two thresholds, and the electric machine is controlled according to this comparison. The invention also relates to a propulsion system suited for this method and to a coupled assembly comprising the propulsion system and a rolling object.

### CROSS-REFERENCE TO RELATED APPLICATIONS

Reference is made to PCT/EP2020/078766 filed Oct. 13, 2020, designating the United States, and French Application No. 19/11852 filed Oct. 23, 2019, which are incorporated herein by reference in their entirety.

### BACKGROUND OF THE INVENTION

### Field of the Invention

The invention relates to transporting rolling objects, in particular rolling beds, hospital beds for example.

### Description of the Prior Art

Moving rolling heavy loads can cause users, from repeated actions to develop musculoskeletal disorders.

In order to roll heavy loads (for example a rolling bed whose total mass is close to or exceeds 500 kg) easier and more ergonomic, it has been considered to equip these heavy loads with electric machines. For example, a first attempt was to provide each hospital bed with an electric system for driving at least one wheel or to add a motorized wheel thereto. Such a solution is expensive because it requires changing or modifying all the beds, which hospitals cannot afford. Furthermore, the drive system and the battery increase the weight of the bed. Therefore, when the battery is discharged, the effort required to move the bed is greater.

Similarly, in the field of logistics or trade, it has been suggested to make all trolleys electric. Again, such a solution is expensive.

One alternative is to provide a removable propulsion system for rolling objects. Several technical solutions have been considered.

For example, patent application WO-01/85,086 describes a motorized propulsion system for a bed. The propulsion system is configured for coupling to one or more points of the bed. Due to the coupling provided for this propulsion system, this system cannot be universal and be suitable for different rolling objects. Indeed, it cannot be coupled to a rolling object which is not provided with a coupling part. In addition, for this propulsion system, all the wheels of the rolling object remain in contact with the ground. Therefore, the orientation of the coupled assembly (propulsion system and bed) is more complicated, the frictional forces are high and a motorized wheel requires more power.

Patent application WO-2012/171,079 describes a second propulsion system for a hospital bed. The propulsion system is configured to lift two wheels of the bed. However, the wheel gripping mechanism is complex and bulky. The lateral dimension (direction parallel to the axis of the motorized wheels) is great (greater than the width of the bed wheels) and it can exceed the lateral dimensions of the bed, which may be inconvenient for moving the bed, in particular in a reduced space such as a hospital corridor or elevator.

Patent application WO-2013/156,030 describes a third propulsion system for a hospital bed. The propulsion system is configured to lift two wheels of the bed. However, the system has great lateral (direction parallel to the axis of the motorized wheels) and longitudinal (direction perpendicular to the axis of the wheels) dimensions. The rear platform protrudes from the bed and the distance between the non-motorized wheels can exceed the dimensions of the bed, which may be inconvenient for moving the bed, in particular in a reduced space such as a hospital corridor or elevator.

Another removable electric propulsion system has been the subject of a patent application filed by the applicant (FR-1,873,165). This system is space saving and adaptable to different rolling objects. It is provided with at least one wheel driven by an electric machine. However, the system has no control strategy. It can be improved so as to efficiently control the electric machine.

### SUMMARY OF THE INVENTION

To automate control of these propulsion systems, the present invention is a method of controlling a removable electric propulsion system for a rolling object. The propulsion system comprises at least one wheel driven by an electric machine. The control method comprises the following steps:
a) measuring at least one signal representative of torque exerted by the rolling object on the propulsion system at the driven wheel wherein the signal representative of the torque may be a torque, an effort or an elongation,
b) comparing the measured signal with at least a first threshold and with at least a second threshold wherein the first threshold being less than the second threshold,
c) controlling the electric machine: so that
if the measurement is less than the first threshold for a first duration, the setpoint of the torque exerted by the electric machine on the driven wheel is decreased by a first predetermined value; and
if the measurement is greater than the second threshold for a second duration, the setpoint of the torque exerted by the electric machine on the driven wheel is increased by a second predetermined value.

Thus, control of the electric machine allows accelerating or slowing down the electric machine, and therefore the removable electric propulsion system, to automatically adjust to the user's needs. Indeed, when the user acts upon the electric propulsion system, for example by a handlebar, or directly by acting upon the object to be moved, in order to accelerate or slow down the electric propulsion system, this manual action is transmitted to the driven wheel whose torque is then modified (torque increase if the user wants to accelerate, torque decrease if the user wants to slow down). Measuring a signal representative of this torque can then detect a change in the request. The control method makes it possible to adjust the setpoint of the electric machine so as to meet the user's request. The setpoint of the electric machine is increased if the user wants to accelerate and, in the opposite case, it is decreased if the user wants to slow down.

According to a variant of the method of the invention, if, in step c), the measurement ranges between the first threshold and the second threshold, the setpoint of the torque exerted by the electric machine on the driven wheel is maintained.

According to an alternative, if, in step c), the measurement ranges between the first threshold and the second threshold, the setpoint of the torque exerted by the electric machine on the driven wheel is decreased by predefined increments, until it stops.

Preferably, in step c), the setpoint is decreased by using an energy dissipation means connected to the electric machine.

Advantageously, the first threshold is negative and the second threshold is positive.

Preferably, the first duration is equal to the second duration.

According to an implementation of the invention, the first predetermined value is equal to the second predetermined value.

According to an embodiment of the invention, the first predetermined value depends on the difference between the measured signal and the first threshold.

According to a configuration of the invention, the second predetermined value depends on the difference between the measured signal and the second threshold.

Preferably, if the measurement is less than a third threshold for a third duration, the third threshold being less than at least one of the first threshold and the third duration being less than the first duration, the setpoint of the electric machine is decreased by a third predetermined value.

Preferably, if the measurement is greater than a fourth threshold for a fourth duration, the fourth threshold being at least one of greater than the second threshold and being less than the second duration, the setpoint of the electric machine is modified by a fourth predetermined value, the fourth predetermined value being greater than the second predetermined value.

According to a variant of this embodiment, the setpoint of the electric machine is increased by a fourth predetermined value.

According to another alternative of this embodiment, the setpoint of the electric machine is decreased by a fourth predetermined value so as prevent runaway of the system.

According to an advantageous implementation, the measurement of the signal representative of the torque exerted by the rolling object on the propulsion system at the driven wheel is corrected, preferably when the measurement of the signal representative of the torque ranges between the first threshold and the second threshold, prior to comparing this corrected measurement with the first and second thresholds.

The invention also relates to a removable electric propulsion system for a rolling object, the propulsion system comprising a chassis provided with at least one wheel driven by an electric machine, at least one non-driven wheel and means for coupling the propulsion system to the rolling object, the means for coupling comprising means for gripping and lifting at least one wheel of the rolling object. The propulsion system comprises a means for measuring a signal representative of the torque exerted by the rolling object on the propulsion system at the driven wheel and a means of controlling the electric machine suited for implementation of the control method described above.

Advantageously, the coupling means comprise means for orienting at least one wheel of the rolling object in a direction substantially perpendicular to the longitudinal direction of the chassis of the propulsion system.

According to an embodiment of the invention, at least one of the driven wheels is an off-centered wheel orientable about a substantially vertical axis, and the propulsion system comprises a means of controlling the electric machine to control the electric machine depending on the measurements obtained by the measuring means.

The invention further relates to a coupled assembly comprising a rolling object and an electric propulsion system according to one of the above features, the rolling object being coupled to the electric propulsion system by the means for coupling.

Preferably, the rolling object is a rolling bed, a trolley, a rolling piece of furniture or a wheelchair.

### BRIEF DESCRIPTION OF THE DRAWINGS

Other features and advantages of the control method and of the system according to the invention will be clear from reading the description hereafter of embodiments given by way of non-limitative example, with reference to the accompanying figures wherein:

FIG. 1 shows a first embodiment of a control method according to the invention;

FIG. 2 shows a second embodiment of a control method according to the invention;

FIG. 3 shows a third embodiment of a control method according to the invention;

FIG. 4 shows a first example of a control method according to the invention;

FIG. 5 shows a second example of a control method according to the invention;

FIG. 6 shows an example of a first variant of the control method according to the invention of FIG. 4;

FIG. 7 shows an example of a second variant of the control method according to the invention of FIG. 4;

FIG. 8 is a cross-sectional overview, in the longitudinal direction, of a propulsion system according to the invention;

FIG. 9 is a top view of a propulsion system according to the invention;

FIG. 10 is a cross-sectional view, in the longitudinal direction, of a first embodiment of the system according to the invention;

FIG. 11 shows an operating mode of the system according to the invention in a given direction; and

FIG. 12 shows an operating mode of the system according to the invention in the opposite direction from the direction of FIG. 11.

### DETAILED DESCRIPTION OF THE INVENTION

The invention relates to a method of controlling a removable electric propulsion system for a rolling object. Moreover, the removable electric propulsion system allows assisting the transport of the rolling object. The rolling object can notably be a hospital bed whose mass to be transported can reach about 500 kg. The electric propulsion system is removable and it can therefore be coupled to or uncoupled from the rolling object. A single propulsion system can thus be used for transporting different rolling objects at different times. It therefore requires less investment than a specific electric system permanently mounted on each rolling object concerned.

The removable electric propulsion system notably has at least one wheel driven by an electric machine. This driven wheel provides assistance for moving the rolling object, thus allowing the user such as a stretcher-bearer for a hospital bed for example, less physical effort for moving the rolling object.

In this control method, the following steps are carried out:
measuring at least one signal representative of torque exerted by the rolling object on the propulsion system at the driven wheel. A measuring means integrated in the electric propulsion system can be used therefore. This measurement provides information on the torque variation of the driven wheel. The torque applied onto the wheel from the electric machine being known (by a setpoint applied to the electric machine), the torque variation can be explained as either due to the user or to variations induced by the wheel/ground contact (slope, holes, door sills, etc.). The user can for example act upon the rolling object or on the propulsion system by means of a handlebar for example,
comparing the measured signal with at least a first threshold and with at least a second threshold wherein the first threshold is less than the second threshold. This comparison can be achieved for example by a computer, or an electronic system capable of communicating with the means for measuring. The first and second thresholds can be predefined, for example by subjecting the system to real-life tests,
controlling the electric machine of the driven wheel so that:
   if the measurement is less than the first threshold for a first duration, the first threshold and the first duration being predefined, the setpoint of the torque exerted by the electric machine on the driven wheel is decreased by a first predetermined value, which causes the electric machine and the system to slow down, and
   if the measurement is greater than the second threshold for a second duration, the setpoint of the torque exerted by the electric machine on the driven wheel is increased by a second predetermined value, thus causing acceleration of the electric machine and the system.

Preferably, the first and second thresholds are different.

A measurement less than (respectively greater than) a threshold (first threshold, respectively second threshold for example) for a certain duration is understood to mean that the measurement obtained remains less than (respectively greater than) the threshold being considered (first threshold, respectively second threshold for example) throughout the duration considered (first duration, respectively second duration for example). In each measuring time increment, the measurement must remain less than (respectively greater than) the threshold considered for the measurement to be considered to be less than (respectively greater than) the threshold.

The setpoint of the electric machine is thus varied incrementally. During a first increment, the measurement of the signal considered is compared with the two thresholds (first and second thresholds). If the measurement is less than (respectively greater than) the first threshold (respectively the second threshold) during the time increment (first duration, respectively second duration), then the setpoint of the electric machine is modified for the next time increment to adjust more rapidly to the measurement to meet the user's needs more rapidly.

Furthermore, owing to the definition of predefined durations, jolts caused by getting over door sills or holes in the ground do not require making unnecessary changes to the setpoint with over-thresholds being of very short durations less than at least one of the first and the second duration. On the other hand, with a force exerted by the user forward or backward for a duration greater than the second or the first duration respectively, to accelerate or to slow down respectively, the system modifies the setpoint of the electric machine to cause it to accelerate or decelerate. The system thus adjusts automatically to the user's needs by application of a short load, a short load (or pulse) being understood to be, within the context of the invention, a force that is maintained for a duration greater than the first or second durations so as to enable reaction of the system. The user can thereafter relax the force applied, which needs not be maintained afterwards.

The method is also particularly advantageous because the user needs no remote control or control box for controlling the system. On the contrary, the user operates the rolling object manually, and the system responds intuitively and automatically to the action exerted by the user.

Advantageously, if, during the step of controlling the electric machine, the measurement ranges between the first threshold and the second threshold, the setpoint of the torque exerted by the electric machine on the driven wheel can be maintained. A measurement ranging between the first threshold and the second threshold is understood to be a measurement that is neither less than the first threshold over the first duration nor greater than the second threshold over the second duration. The setpoint of the electric machine is not modified. Moving the rolling object can thus be continued without any user effort. A battery or any other energy storage means can be used for powering the electric machine.

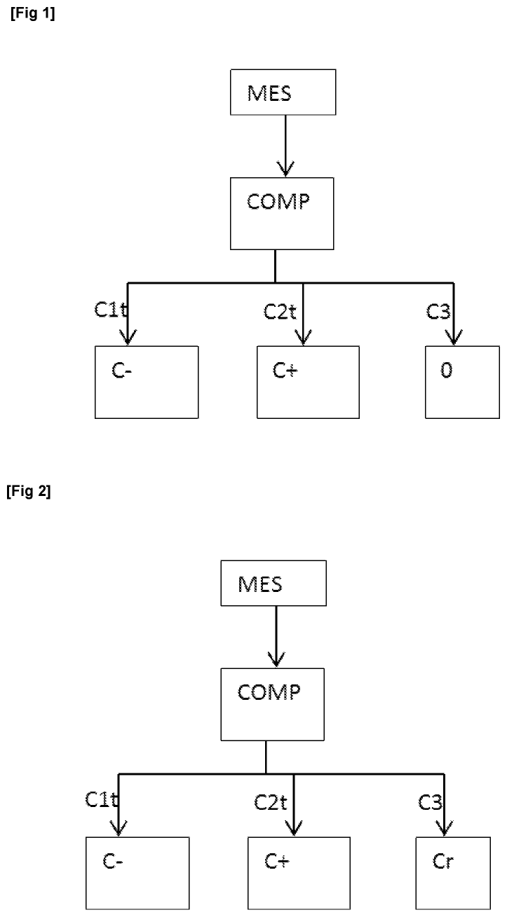

FIG. 1 schematically illustrates, by way of non-limitative example, an example of a control method for a removable electric propulsion system according to the invention. In this control method, a signal representative of the torque exerted on the driven wheel of the removable electric propulsion system is measured (MES). The torque at the driven wheel is determined from the measurements performed and it is compared with the setpoint of the electric machine. This allows determination of whether an action is performed by the user to either accelerate or slow down the system.

The measurements performed are then compared (COMP) with at least a first threshold for a first duration and at least a second threshold for a second duration. These two thresholds are predefined according to the rolling object for at least one of operating situations and the user, by use of, for example of experimentations carried out on the system. A measurement less than (respectively greater than) a first threshold (respectively a second threshold) for a first duration (respectively a second duration) is understood to mean that the measurement is less than (respectively greater than) the threshold considered throughout the duration being considered. Therefore, if part of the measurement performed is greater than the first threshold (respectively less than the second threshold) for the first duration (respectively the second duration), the measurement is not considered to be less than the first threshold for the first duration (respectively greater than the second threshold for the second duration).

If the measurement is less than the first threshold for a first duration (condition C1t), the torque setpoint of the electric machine is decreased (C−) so as to slow the electric machine (and therefore the removable electric propulsion system) down.

If the measurement is greater than the second threshold for a second duration (condition C2t), the torque setpoint of the electric machine is increased (C+) so as to accelerate the electric machine (and therefore the removable electric propulsion system).

In any other case, when at least part of the measurement performed over the duration is considered ranges between the first threshold and the second threshold (condition C3). It is assumed that the measurement ranges between the first threshold and the second threshold, and the previous setpoint is maintained for the electric machine (setpoint 0). It should be noted that control of the electric machine is performed by incremental time intervals corresponding to time increments of durations corresponding to the first duration (for the first threshold) and to the second duration (for the second threshold). Prior to starting the control process, for initialization thereof, the setpoint of the electric machine is considered to be zero (no setpoint). The setpoint is applied to the increment following the measuring increment.

Alternatively, if, during the step of controlling the electric machine, the measurement ranges between the first threshold and the second threshold, the setpoint of the torque exerted by the electric machine on the driven wheel can be progressively decreased, by predefined increments, until the electric machine stops. This option has the advantage of enabling the system to stop after a while, which limits collision risks if the user fails to stop/slow down the system. Furthermore, this solution is close to the natural operation of the system (natural operation is understood to be operation without electric assistance), it therefore makes it possible for the user to become gradually accustomed to the electric-assistance system. During natural operation, as a result of a force exerted by the user on the system, the system is set in motion but it tends to stop by itself. When progressively decreasing the torque setpoint, the system reacts as if frictional forces tended to stop it.

FIG. 2 schematically illustrates, by way of non-limitative example, another example of a control method suited for the system according to the invention. In this control method, a signal representative of the torque exerted at the driven wheel of the removable electric propulsion system is measured (MES).

The measurements performed are then compared (COMP) with at least a first threshold for a first duration and with a second threshold for a second duration. These two durations are predefined according to the rolling object, to at least one of the operating situations and/or to the user.

If the measurement is less than the first threshold for a first duration (condition C1t), that is if all the measuring points performed in the time interval of the first duration are less than the first threshold, the torque setpoint of the electric machine is decreased (C−) to slow the electric machine (and therefore the removable electric propulsion system) down.

If the measurement is greater than the second threshold for a second duration (condition C2t), i.e. if all the measuring points performed in the time interval of the second duration are greater than the second threshold, the torque setpoint of the electric machine is increased (C+) to accelerate the electric machine (and therefore the removable electric propulsion system).

In any other case, that is when the measurement ranges between the first threshold and the second threshold (condition C3), that is the measurement is neither less than the first threshold over the first duration nor greater than the second threshold over the second duration, the previous setpoint of the electric machine is decreased (setpoint Cr) by predefined increments. The setpoint increments can thus be constant or, on the contrary, defined to increase slow-down progressively until the electric machine stops. Thus, over each time increment where the user does not act upon the system to control an acceleration or a deceleration, the system progressively slows down until it stops.

This progressive energy dissipation for slowing down the system can notably be achieved using energy dissipation means (mechanical brake, resistive electrical elements and/or use of the electric machine as a generator for recharging the batteries for example) connected to the electric machine.

Advantageously, the first threshold can be negative and the second threshold can be positive. Therefore, when the measurement exceeds the second threshold, the setpoint of the electric machine is increased; on the contrary, when the measurement is less than the first threshold, the setpoint of the electric machine is reduced until full standstill of the machine. Furthermore, control of the system is simplified.

Moreover, the first threshold can be the opposite of the second threshold. The system therefore has a symmetrical acceleration and braking behavior.

According to a variant of the method of the invention, the first duration can be equal to the second duration. This allows the number of parameters of the system to be reduced. Furthermore, this enables the user to better anticipate the system behavior (for example in order to determine the load holding time required for the system to react). This variant is advantageous because it also allows simplification of the control method by performing comparisons in the same time intervals for the first threshold and the second threshold.

According to an embodiment of the invention, the first predetermined value can be equal to the second predetermined value. The acceleration and deceleration phases are therefore symmetrical, which enables the user to better anticipate the system behavior.

Advantageously, the first predetermined value can depend on the difference between the measured signal and the first threshold. In other words, the first predetermined value may not be a predetermined constant, but rather a predefined function. Thus, if the difference between the measured signal (for example the average of the measured signal over the first duration) and the first threshold increases, the setpoint also increases, linearly for example. Other curves could however be used. This allows the user's needs to be met more rapidly and more efficiently.

Advantageously, the second predetermined value can depend on the difference between the measured signal and the second threshold. In other words, the second predetermined value may not be a predetermined constant, but rather a predefined function. Thus, if the difference between the measured signal (for example the average of the measured signal over the second duration) and the second threshold increases, the setpoint also increases, linearly for example. Other curves could however be used. This allows the user's needs to be met more rapidly and more efficiently.

According to an implementation of the method of the invention, if the measurement is less than a third threshold over a third duration, the third threshold being less than the first threshold, the setpoint of the electric machine can be modified by a third predetermined value. The third predetermined value can be greater than the first predetermined value for example. Therefore, if braking is required for example for passing over a small hole in the ground or if the system is subjected to an ascending slope, the system can increase the setpoint to prevent stopping.

In some cases, the third duration can be less than the first duration. This may allow to detect an occasional braking peak.

According to a preferred variant of this implementation, the setpoint of the machine can be set to zero for performing an emergency stop.

According to an embodiment of the control method, if the measurement is greater than a fourth threshold over a fourth duration with the fourth threshold being greater than the second threshold, the setpoint of the electric machine can be modified by a fourth predetermined value, the fourth predetermined value being preferably greater than the second predetermined value.

According to an implementation of the method, the setpoint of the electric machine can be increased by a fourth predetermined value. Thus, if the system detects a power requirement, the system can automatically increase the setpoint to meet the user's needs more rapidly and more efficiently.

According to another implementation of the method, the setpoint of the electric machine can be decreased by a fourth predetermined value to prevent runaway of the system. Runaway of the system can thus be prevented beyond the fourth threshold.

According to an alternative, the fourth threshold can be used for increasing or decreasing the setpoint of the electric machine depending on the various measuring parameters in order to determine whether the over-threshold is due to an occasional power peak or to a runaway risk.

According to a variant, the fourth duration can be less than the second duration. This may allow an occasional power peak to be detected.

Preferably, the measurement of the signal representative of the torque exerted on the rolling object by the propulsion system at the driven wheel can be corrected prior to comparing this corrected measurement with the various thresholds (first, second and possibly third and/or fourth thresholds when used), for example when the measurement of the signal representative of the torque ranges between the first threshold and the second threshold. The correction can for example be brought back to zero.

This correction can notably allow overcoming the discrepancies that may occur in the system and performing an automatic recalibration.

This correction can also prevent a runaway of the system when subjected to a descending slope. Indeed, when the system remains for a specific period between the first threshold and the second threshold, a correction can be made to bring the measurement back to zero. Since the measurement is brought to zero, the setpoint of the electric machine remains constant. This correction allows avoiding overrun of the second threshold. Indeed, without measurement correction, if the system continues its descent along the slope, overrunning of the second threshold might occur, which would result in increasing the setpoint of the electric machine and thus accelerating the system whereas it is not desirable.

Similarly, this correction could also make it possible to prevent the system from stopping when subjected to an ascending slope. Indeed, when the system remains for a specific period between the first threshold and the second threshold, a correction can be made to bring the measurement to zero, thus performing a recalibration. Since the measurement is brought to zero, the setpoint of the electric machine remains constant. This correction avoids dropping below the first threshold. Indeed, without the measurement correction, if the system continues its ascent along the slope, the value might drop below the first threshold, which would result in decreasing the setpoint of the electric machine and thus in stopping the system, which is not desirable.

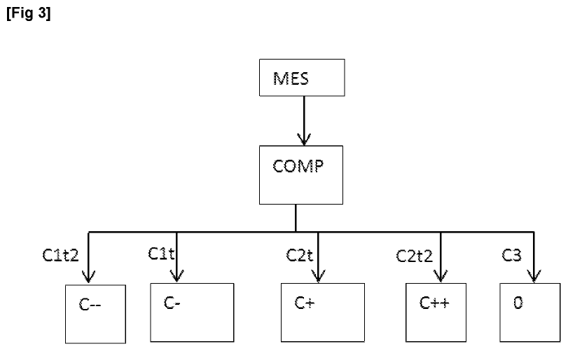

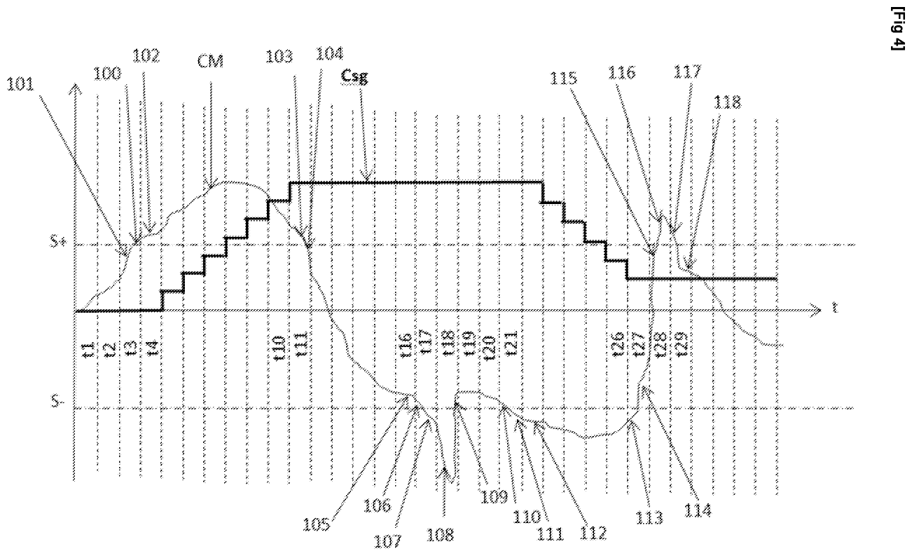

FIG. 3 schematically illustrates, by way of non-limitative example, another example of a control method suited to the system according to the invention. In this control method, a signal representative of the torque exerted at the driven wheel of the removable electric propulsion system is measured (MES).

The measurements performed are subsequently compared (COMP) with at least a first threshold for a first duration and with at least a second threshold for a second duration. These two thresholds are predefined according to the rolling object, to operating situations and to the user. If part of the measurement performed is greater than the first threshold (respectively less than the second threshold) for the first duration (respectively the second duration), the measurement is not considered to be less than the first threshold for the first duration (respectively greater than the second threshold for the second duration). In this method, the measuring increment is the same for comparing the measurement with the first and second thresholds. This means that the first duration is equal to the second duration.

If the measurement is less than the first threshold for a first duration (condition C1t), the torque setpoint of the electric machine is decreased (C−) which slows the electric machine (and therefore the removable electric propulsion system) down.

If the measurement is less than a third threshold for a third duration (condition C1t2), the torque setpoint of the electric machine (C−−) is decreased, the third threshold being less than the first threshold, the decrease of setpoint C—being greater than the decrease of setpoint C− to increase the deceleration of the electric machine (and therefore of the removable electric propulsion system).

If the measurement is greater than the second threshold for a second duration (condition C2t), the torque setpoint of the electric machine is increased (C+) to accelerate the electric machine (and therefore the removable electric propulsion system).

If the measurement is greater than a fourth threshold for a fourth duration (condition C2t), the fourth threshold being greater than the second threshold, the torque setpoint of the electric machine is increased (C++), the setpoint increase being greater than the increase of setpoint C+ so as to accelerate the electric machine (and therefore the removable electric propulsion system).

In any other case, when at least part of the measurement performed over the duration being considered ranges between the first threshold and the second threshold (condition C3), the previous setpoint is maintained for the electric machine (setpoint 0). The previous setpoint is therefore not modified in this case.

The invention also relates to a removable electric propulsion system for a rolling object. The system comprises a chassis provided with at least one wheel driven by an electric machine, at least one non-driven wheel, a handlebar and a coupling of the propulsion system to the rolling object. Furthermore, the coupling comprises means for gripping and lifting at least one wheel of the rolling object. The propulsion system comprises a means for measuring a signal representative of the torque exerted by the rolling object on the propulsion system at the driven wheel. The propulsion system notably comprises a means for controlling the electric machine suited for implementing the control method described above. The system can therefore automatically react to the driver's demand to adjust the travel speed of the removable electric propulsion system (and of the rolling object). The coupling provides transmission of the motion of the removable electric propulsion system to the rolling object. Advantageously, the removable electric propulsion system can also comprise measuring using sensors for torque, force, elongation or rotating speed.

Advantageously, the method and the system according to the invention can use a single sensor within the system. The system and the method are thus simplified.

According to a preferred implementation of the system of the invention, the coupling can comprise means for orienting at least one wheel of the rolling object in a direction substantially perpendicular to the longitudinal direction of the propulsion system chassis. Thus, a relative motion of the rolling object with respect to the electric propulsion system can be blocked. Furthermore, this feature is advantageous because it provides adjustment for different rolling objects.

Advantageously, at least one of the driven wheels can be an off-centered wheel orientable around a substantially vertical axis. This specific feature allows the system to be automatically oriented, without a controlled orientation means, by the eccentricity of the wheels in relation to the vertical axis serving as a pivot for connection to the chassis. The system thus orients itself in the desired direction when the user acts through the agency of a handlebar or of the rolling object to modify the direction of travel. The control process thus only needs to control the speed of the system without actively controlling the direction with the system enabling passive control of the direction, simplifying the control system and method.

Furthermore, the propulsion system can comprise an electric machine control for controlling the electric machine according to the measurements obtained by the measuring sensors. The control can notably include a controller. The control is suitable for implementation of the method described above. Thus, control is automatic from short driver requests.

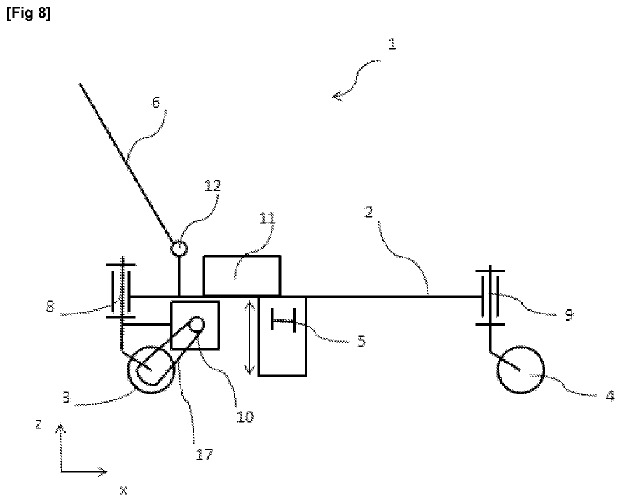

FIG. 8 schematically illustrates, by way of non-limitative example, an electric propulsion system according to the invention. FIG. 8 is a cross-sectional side view of removable electric propulsion system 1. Removable electric propulsion system 1 comprises a chassis 2. Axis x corresponds to the longitudinal axis of chassis 2 and to the principal direction of displacement of the propulsion system, and axis z corresponds to the vertical axis of chassis 2. The chassis supports three wheels. Chassis 2 supports a wheel 3 that is driven by an electric machine 10 by a transmission 17, a belt or a chain (alternatively, electric machine 10 can be directly connected to wheel 3). Wheel 3 is orientable relative to chassis 2, around a vertical axis 8 referred to as pivot connection. Preferably, orientation is automatic and requires no controlled orientation means. In other words, the system has no active orientation means. Electric machine 10 can be integral with pivot connection 8 of the motorized wheel 3. At the other end, chassis 2 supports two wheels 4, which are not driven by an electric machine. Wheels 4 are orientable relative to the chassis around vertical axes 9. Each wheel, driven or not, is thus orientable around a vertical axis. Electric propulsion system 1 further comprises a coupling 5. According to the illustrated embodiment, electric propulsion system 1 comprises two couplings 5, on either side of the chassis along the lateral direction (axis y not shown) which provide coupling by two wheels of the rolling object (not shown). Couplings 5 are shown in a simplified manner as clamps. The vertical motion of the couplings 5 is shown by a double arrow. This vertical motion of the couplings can be of gripping and lifting the wheels of the rolling object.

Couplings 5 are arranged, in direction x, between motorized wheel 3 and non-motorized wheels 4. Furthermore, electric propulsion system 1 comprises a handlebar 6, for example in the form of a rod equipped with a handle (not shown) articulated with respect to chassis 2 by a joint 12 of horizontal axis, along lateral direction y of chassis 2 (perpendicular to the plane of the figure). Other modes of use can be utilized: for example, the handlebar can be connected to pivot connection 8. Moreover, electric propulsion system 1 comprises a battery 11. Battery 11 is arranged on chassis 2, close to electric machine 10 and motorized wheel 3, and it supplies power to the electric machine.

Battery 11 can be removable. It can therefore be removed and readily replaced with a charged battery, with no waste of time due to battery recharging. It can also be rack-mounted to be slidably engaged for example in a frame or platform (referred to as rack, which corresponds to an enclosure for mounting electronic equipment modules) provided in a compartment where the electric connection can be pre-wired. With rack mounting, connection is automatic upon installation of the device. Therefore, mounting (or dismounting) the battery on the rack is fast and easy.

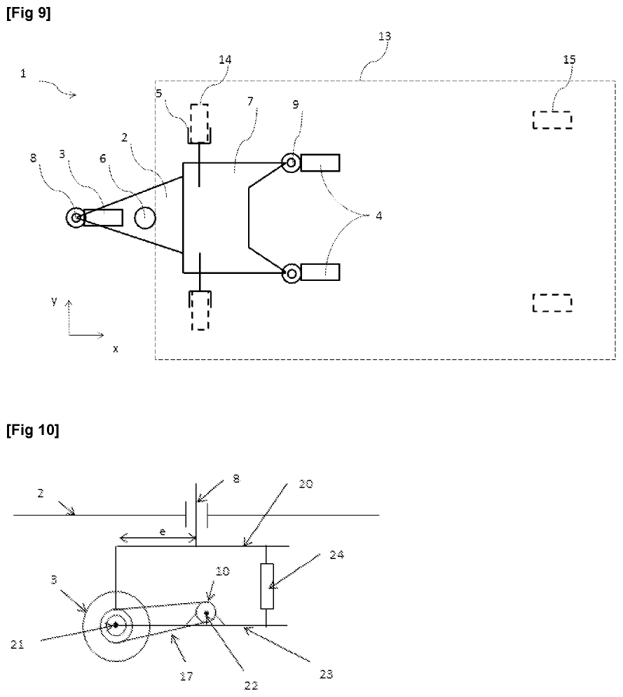

FIG. 9 schematically illustrates, by way of non-limitative example, an electric propulsion system according to an embodiment of the invention coupled to a rolling object 13. FIG. 9 is a top view of electric propulsion system 1 and of the rolling object 13. Rolling object 13 can be of any type, notably a rolling bed. The rolling object comprises two wheels 14, arbitrarily referred to as rear wheels, and two wheels 15, arbitrarily referred to as front wheels. Electric propulsion system 1 comprises a chassis 2. Axis x corresponds to the longitudinal axis of chassis 2 and to the principal direction of travel of the propulsion system, axis y corresponds to the lateral axis of chassis 2, and with the vertical axis z not being shown. Chassis 2 supports three wheels. Chassis 2 supports a wheel 3, which is driven by an electric machine (not shown). Wheel 3 is orientable relative to chassis 2, around a vertical axis 8 (pivot connection). At the other end, chassis 2 supports two wheels 4, which are not driven by an electric machine. Wheels 4 are orientable relative to the chassis around vertical axes 9. Electric propulsion system 1 further comprises couplings 5.

According to the embodiment illustrated, electric propulsion system 1 comprises two couplings 5, on either side of the chassis along the substantially lateral direction (axis y) which provides coupling by two rear wheels 14 of the rolling object. Couplings 5 are shown in a simplified manner as clamps. Rear wheels 14 of the rolling object are within the clamp and are arranged substantially along axis y, which an axis perpendicular to the longitudinal axis (axis x) of chassis 2, which prevents a relative motion in the longitudinal direction of the rolling object and of the electric propulsion system. Furthermore, front wheels 15 of the rolling object are free and not coupled. Electric propulsion system 1 also comprises a handlebar 6, for example in form of a rod equipped with a handle (not shown), which is articulated with respect to chassis 2. Furthermore, electric propulsion system 1 comprises a supporting platform 7 (for example for a user when the electric propulsion system is used in electric scooter mode). Platform 7 is arranged at the end of chassis 2 supports the non-motorized wheels 4. Couplings 5, non-motorized wheels 4, platform 7 and a major part of chassis 2 are arranged beneath the rolling object. Only motorized wheel 3 and handlebar 6 can protrude from rolling object 13 in the longitudinal direction x of chassis 2.

FIG. 10 schematically illustrates, by way of non-limitative example, a sectional view along the transverse axis of an embodiment of the invention.

FIG. 10 illustrates a wheel 3 driven by an electric machine 10. Driven wheel 3 is connected to the chassis by a pivot connection whose axis 8 is substantially vertical. Thus, the wheel can be oriented so as to impart the direction of travel of the electric propulsion system and the rolling object. Axle 8 of the pivot connection between driven wheel 3 and chassis 2 is rigidly fixed to support piece 20. Support piece 20 itself is provided with a pivot connection around axle 21 of driven wheel 3. In the cutting plane of FIG. 10, axle 21 of driven wheel 3 is positioned at a distance e from pivot connection axle 8. Thus, driven wheel 3 is offset relative to pivot connection axle 8 (in other words, it is off-centered from pivot connection axle 8). Thus, driven wheel 3 is an orientable off-centered wheel whose orientation is automatic. It is therefore a passive system with automatic orientation in the direction of travel.

Electric machine 10 is connected to driven wheel 3. In this figure, axle 22 of electric machine 10 is not coaxial with axle 21 of driven wheel 3. A transmission 17 has a belt or chain used for connection and power transmission between electric machine 10 and driven wheel 3. Electric machine 10 is fastened onto a connecting piece 23 which acts as a support plate. Connecting piece 23 is provided with a pivot connection around axle 21 of driven wheel 3. Thus, connecting piece 23 and support piece 20 can pivot with respect to one another around axle 21 of driven wheel 3. A measuring 24 can be positioned between these two pieces, measuring device 24 is fixed on one hand to support piece 20 and on another hand to connecting piece 23 to measure a variation in the distance, the angle, the force or the torque generated between these two pieces. This measuring device 24 can notably be a torque rod allowing measuring the torque variations generated on driven wheel 3 and to block the rotation of connecting piece 23. This measurement allows determination of the torque at driven wheel 3. The value of the torque is then used as a datum for controlling the electric machine by a control (not shown), for example a controller comprising an electronic control equipment.

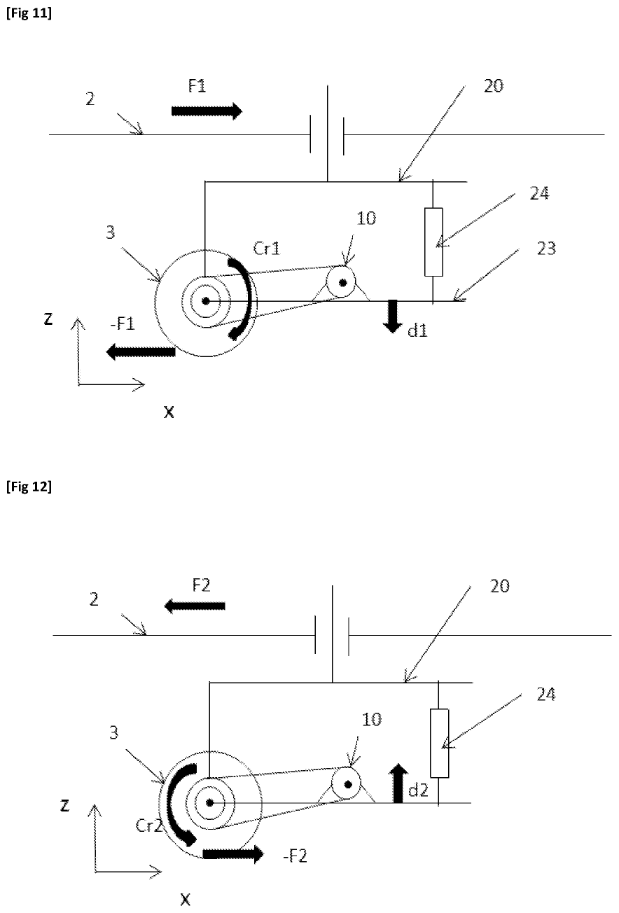

FIGS. 11 and 12 illustrate operating modes corresponding to the removable electric propulsion system of FIG. 10.

In FIG. 11, the user acts upon the handlebar or the rolling object by a force F1 transmitted to chassis 2, then to support piece 20 and eventually to driven wheel 3. Force F1 is collinear with direction x considered as a forward direction. This force creates a reaction—F1 at the contact between driven wheel 3 and the ground (not shown). A torque Cr1 created by force F1 is generated at driven wheel 3. This torque Cr1 generated on driven wheel 3 creates a rotation of the driven wheel, partly countered by the resisting torque of the electric motor, and a rotation of connecting piece 23 around the axis of driven wheel 3, generating a downward motion of connecting piece 23 (in the opposite direction to z). Thus, the measuring device can then detect an elongation d1 or an increase in the angle or the force between support piece 20 and connecting piece 23. The measuring device 24 can for example be a torque rod. The control can then control the electric machine to increase the generated torque (or the rotating speed). Thus, the system can accelerate and the speed can then be maintained without any user effort. A simple impulse generated by the user is enough to obtain an acceleration. Furthermore, since the driven wheels are automatically oriented in the direction of travel, the measurement performed by the measuring means is always carried out in the direction of travel, which notably overcomes parasitic forces in other directions.

In FIG. 12, the user acts upon the handlebar or the rolling object by a force F2 transmitted to chassis 2, then to support piece 20 and eventually to driven wheel 3. Force F2 is in an opposite direction to direction x of force F1 of FIG. 11; force F2 is in backward direction. This force creates a reaction—F2 at the contact between driven wheel 3 and the ground (not shown). A torque Cr2 created by force F2 is generated at driven wheel 3. This torque Cr2 generated on driven wheel 3 creates a rotation of connecting piece 23 around the axis of driven wheel 3, generating an upward motion of connecting piece 23 (in direction z). Thus, the measuring device can then detect a decrease d2 in the length, the angle or the force between support piece 20 and connecting piece 23. The control can then control the electric machine to decrease the generated torque (or the rotating speed). Thus, the system can slow down or decrease the travel speed by a simple backward impulse from the user. The system then allows this reduced speed to be maintained without any user effort.

FIGS. 11 and 12 describe the operating principle of the system in direction x corresponding to the longitudinal direction of the chassis. The wheels are automatically orientable in the direction of travel due to the eccentricity of the wheel with respect to the pivot connection between the wheel and the chassis. The effect of the operation illustrated in FIGS. 11 and 12 can be applied in any desired direction of travel.

The invention also relates to a coupled assembly made up of a rolling object and an electric propulsion system as described above, the rolling object being coupled to the electric propulsion system by the coupling means. Thus, the rolling object can be moved in a simple manner, with limited user interaction. It requires no remote control and reacts in a quasi-intuitive manner to the user's requests.

Advantageously, the rolling object is a rolling bed, a trolley, a rolling piece of furniture or a wheelchair. These heavy and bulky loads can thus be readily moved while limiting musculoskeletal disorder risks for the user. Moreover, since the electric propulsion system has reduced dimensions, the size of the coupled assembly thus achieved is also reduced, which allows it to be maneuvered even in tight spaces.

### Examples

FIGS. 4 to 7 illustrate examples of control methods for a removable system providing electric propulsion of rolling objects according to the invention.

FIG. 4 corresponds to the embodiment of FIG. 1. FIG. 4 shows a measuring curve CM of a signal representative of the torque at the driven wheel, measured by the measuring means (torque sensor for example) of the removable electric propulsion system over time t. In each time increment, the increments being delimited by two successive vertical lines (perpendicular to the time axis t) in dash-dot line, the measurement is compared, in each increment considered, with thresholds S− and S+ corresponding to a first threshold (S−) and to a second threshold (S+) respectively. For the measurement to be considered less than a threshold, for example less than first threshold S−, the measurement needs to be less than the threshold over the duration of the increment considered. Similarly, the measurement is considered to be greater than a threshold, for example second threshold S+, if the measurement is greater than threshold S+ over the duration of the increment, the increment corresponding to the interval between two successive dotted vertical lines, the comparison increment being here identical for comparison of measurement CM with first threshold S− and second threshold S+. In other words, the first duration and the second duration over which the measurement is compared with the first and second thresholds (S− and S+) are identical, which simplifies the analysis.

Between the initial time when the signal is zero (no torque at the driven wheel) and t1, an increase in the signal of curve CM is observed, which means that a motion is initiated in the system. However, over this entire first duration, the first increment stopping at time t1, measuring curve CM remains between S− and S+ so that the setpoint Csg of the electric machine is maintained. As it is the starting of the machine, the electric machine is initially at standstill, the initial setpoint Csg is zero. Thus, setpoint Csg of the electric machine is now zero between time t1 and time t2 representing the next increment.

During the increment between time t2 and time t3, part 100 of the measurement is greater than threshold S+. However, part 101 of the measurement is less than threshold S+. Thus, measurement CM cannot be considered to be greater than threshold S+ in the time increment between time t2 and time t3. Setpoint Csg thus remains identical for the next increment between time t3 and time t4 to the previous setpoint Csg, corresponding to the setpoint Csg applied between time t2 and time t3.

In the next increment, between time t3 and time t4, the entire measuring curve 102 is greater than threshold S+, setpoint Csg of the electric machine is thus increased in the next increment starting at time t4, which is materialized by the first step observed on setpoint curve Csg.

Between times t4 and t10, measurement CM always remains greater than threshold S+, so that setpoint Csg is increased by steps corresponding to the various increments. It is noted that each step has an identical course. In other words, the setpoint is increased by a predefined constant value.

Between times t10 and t11, part 103 of the curve is actually above threshold S+, but another part 104 of the curve is below threshold S+. Thus, the measurement cannot be considered to be greater than the threshold over the duration of the increment contained between t10 and t11. Thus, the previous setpoint, i.e. defined after time t10 and applied between t10 and t11, is maintained for the increment starting at time t11.

Between time t11 and time t16, curve portion 105 is between S− and S+, torque setpoint Csg is thus maintained until t17.

Between time t16 and time t17, part 107 of the curve is less than threshold S−, but another part 106 of the curve is greater than threshold S−. Thus, curve CM cannot be considered to be less than threshold S− in the increment between t16 and t17. The previous setpoint, applied between time t16 and time t17, is thus maintained between t17 and t18.

Between time t17 and time t18, part 108 of the curve is less than threshold S−, but part 109 of the curve is greater than threshold S−. Thus, curve CM cannot be considered to be less than threshold S− in the increment between t17 and t18. The previous setpoint is thus maintained for the next increment contained between t18 and t19.

Between time t18 and time t20, curve CM remains contained between S− and S+, so that the setpoint is not modified between t19 and t20, or between t20 and t21.

Between time t20 and time t21, part 111 of the curve is actually below threshold S−, but another part 110 of the curve is above threshold S−. Thus, the measurement cannot be considered to be less than threshold S− over the duration of the increment between t20 and t21. Thus, the setpoint applied in the previous increment, contained between time t20 and time t21, is maintained in the increment starting at time t21.

Between time t21 and time t26, curve portion 112 remains less than threshold S. Therefore, in the various increments considered, the setpoint is progressively decreased stepwise. The course of each step is identical. The setpoint decrease is determined by a predefined constant value.

Between time t26 and time t27, part 113 of the curve is below threshold S−, but another part 114 of the curve is above threshold S−. Thus, the measurement cannot be considered to be less than threshold S− over the duration of the increment contained between t26 and t27. Thus, the setpoint applied in the previous increment, contained between time t26 and time t27, is maintained between time t27 and time t28.

Between time t27 and time t28, part 116 of the curve is above threshold S+, but another part 115 of the curve is below threshold S+. Thus, the measurement cannot be considered to be greater than threshold S+ over the duration of the increment between t27 and t28. Thus, the setpoint applied in the previous increment is maintained between time t28 and time t29.

Between time t28 and time t29, part 117 of the curve is above threshold S+ but another part 118 of the curve is below threshold S+. Thus, the measurement cannot be considered to be greater than threshold S+ over the duration of the increment contained between t28 and t29. Thus, the setpoint applied in the previous increment is maintained for the increment starting at t29.

The last part of the curve is between first threshold S− and second threshold S+. Therefore, torque setpoint Csg is maintained constant until the end.

It is noted that, for this embodiment example, the assistance of the electric machine is provided to the system between times t4 and t33, with a setpoint adjusted to the measurement so as to meet the user's needs.

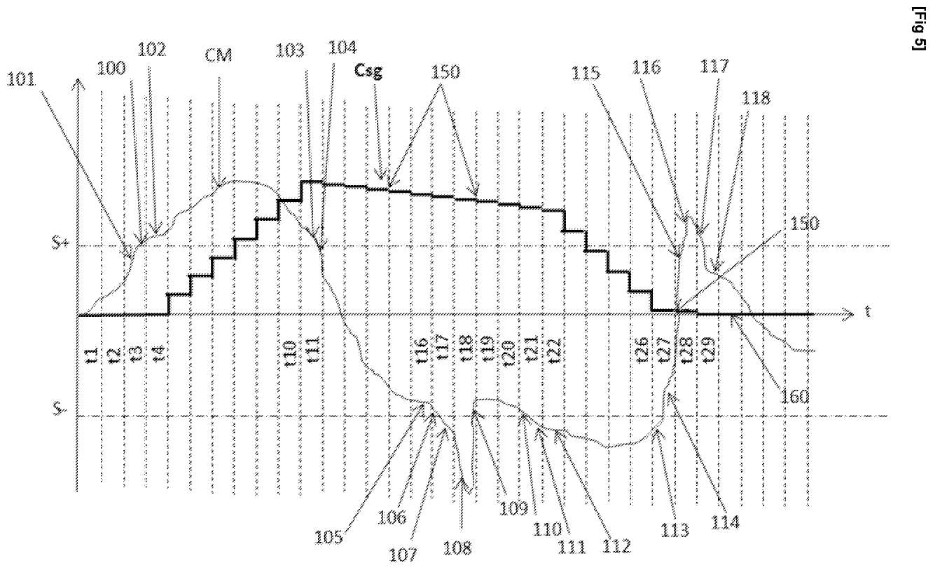

FIG. 5 schematically illustrates, by way of non-limitative example, a second example of the control method according to the invention. The references corresponding to those of FIG. 4 are identical and are therefore not detailed again hereafter. They correspond to the same elements. FIG. 5 corresponds to the embodiment of FIG. 2.

FIG. 5 differs from FIG. 4 by the application of a variant of the control strategy for setpoint Csg between times t11 and t22, corresponding to the end of the increment starting at time t11, then between t27 until the end of setpoint curve Csg. Indeed, in FIG. 4, since the measurement of each increment contained between t10 and t21 corresponds to a measurement between first threshold S− and second threshold S+, setpoint Csg of the electric machine is kept constant between t11 and t22. On the other hand, in FIG. 5, over the same time period between t11 and t22, setpoint Csg of the electric machine is progressively reduced by steps 150, the reduction corresponding to a constant step. Setpoint Csg reduction steps 150 are therefore identical between t11 and t22.

Similarly, over the time period after t27, setpoint Csg of the electric machine is progressively reduced until standstill, whereas in FIG. 4 this setpoint Csg remains constant. Indeed, as between time t26 and time t27, the measurement is considered to be contained between first threshold S− and second threshold S+, the setpoint applied between time t26 and time t27 is reduced by a step 150 between time t27 and time t28. Similarly, the setpoint is reduced between time t28 and time t29 where it reaches a zero value. In the next increments, as the measurement always remains between first threshold S− and second threshold S+, the zero setpoint is maintained since the electric propulsion system has been stopped.

It is noted that, for this embodiment example, the assistance of the electric machine is provided to the system between times t4 and t29, with a setpoint adjusted to the measurement so as to meet the user's needs.

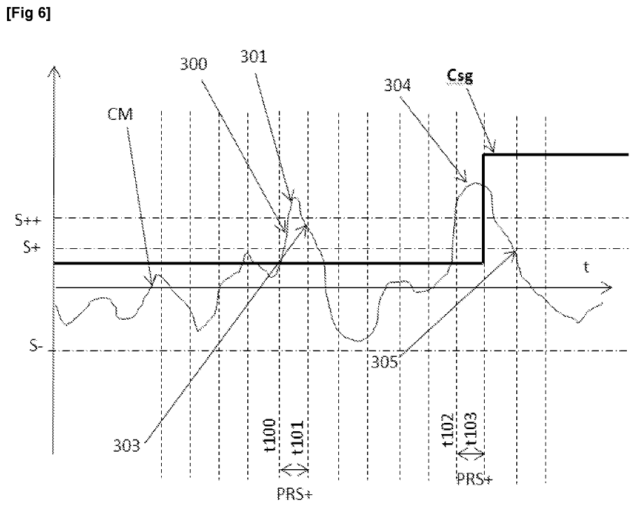

FIG. 6 schematically illustrates, by way of non-limitative example, a first variant of the control method of the electric propulsion system of FIG. 4. In addition to the comparison with thresholds S− and S+ as in FIG. 4, the control of FIG. 6 defines an additional threshold S++ (fourth threshold) greater than threshold S+. This threshold is used to detect occasional power peaks where the setpoint needs to be readjusted. For example, this may be the case if threshold S++ is much greater than threshold S+ or if the power peak is high (to get over a door sill for a hospital bed for example, or in case of a short slope to be ascended by the system), but over a short period. The increment PRS+ considered, contained between two successive vertical lines (perpendicular to time axis t), for comparison of the measurement with threshold S++, can therefore be less than the increment used for FIG. 4, used for comparison of the measurement with thresholds S+ and S− (the increment used for thresholds S+ and S− is not shown in FIG. 6).

In FIG. 6, the measuring curve of the signal representative of the torque at the driven wheel CM is contained between first threshold S− and second threshold S+ before time t100. Setpoint Csg is thus maintained constant until time t101.

Between time t100 and time t101 corresponding to an increment PRS+, part of curve CM remains less than threshold S+ (and a fortiori than threshold S++). The measurement is therefore not greater than second threshold S+. Curve parts 300 and 303 remain less than threshold S++ whereas part 301 is above threshold S++ in the increment PRS+ contained between time t100 and time t101. The measurement therefore cannot be considered to be greater than threshold S++ during increment PRS+ contained between t100 and t101. Torque setpoint Csg is therefore not modified. It is maintained constant over the next increment starting after t101.

Between time t101 and time t102, measuring curve CM is contained between S− and S+ in the various increments considered. Even though curve CM is slightly exceeded just before time t102, this over-threshold does not appear in the entire increment ending at time t102, so that the measurement cannot be considered to be greater than threshold S+ in this increment ending at time t102. The setpoint is thus maintained in the next increment between t102 and t103.

Between time t102 and time t103, curve portion 304 is greater than threshold S++ over the entire increment. Thus, the measurement in increment PRS+ between t102 and t103 is greater than threshold S++ in this increment. Therefore, the setpoint is increased by a value greater than that of the steps of FIG. 4, so as to rapidly supply the power required for the measured peak. A fast response is therefore provided to the user's power request.

Then, in the next increments, the measurement remains between first threshold S− and second threshold S+, including in the increment starting at time t103, because part 305 of the curve is less than threshold S+. Thus, setpoint Csg applied in the increment starting at time t103 is maintained over the whole end of setpoint curve Csg.

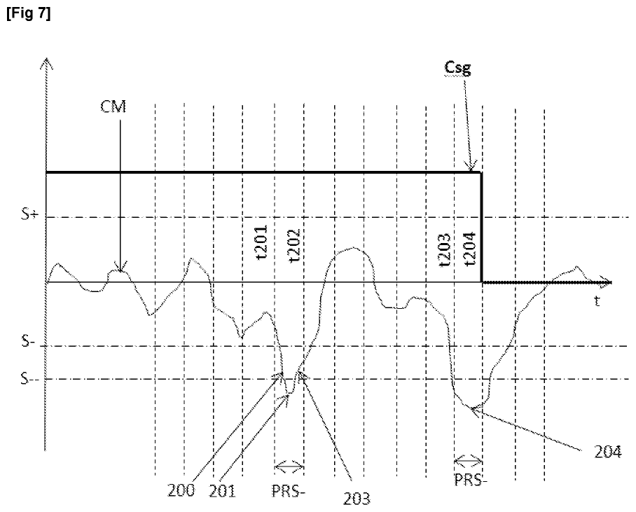

FIG. 7 schematically illustrates, by way of non-limitative example, a second variant of the control method of the electric propulsion system of FIG. 4. In addition to the comparison with thresholds S− and S+ as in FIG. 4, the control of FIG. 7 defines an additional threshold S—(third threshold), less than threshold S−. This threshold S−− is used to detect occasional power decreases where the setpoint needs to be readjusted. For example, this may be the case if threshold S−− is much less than threshold S− (the system needs to be rapidly slowed down for example), or if the power decrease is significant over a short period. This can correspond to the case of a hospital bed transported by the removable electric propulsion system running over a hole or descending a more or less long slope. The increment considered PRS−, contained between two successive vertical lines (perpendicular to time axis t), for comparison of the measurement with threshold S−−, can therefore be less than the increment used for FIG. 4 (the increment used for thresholds S+ and S− is not shown in FIG. 7).

In FIG. 7, the measuring curve of the signal representative of the torque at the driven wheel CM is contained between S− and S+ before time t201. Torque setpoint Csg of the electric machine is thus maintained constant.

Between time t201 and time t202, corresponding to an increment PRS−, part of curve CM remains greater than threshold S− (and a fortiori greater than threshold S−−). Curve parts 200 and 203 remain greater than threshold S—whereas curve part 201 is below threshold S−−. The measurement can therefore not be considered to be less than threshold S—during increment PRS− contained between t201 and t202. Torque setpoint Csg is thus not modified. It is maintained constant over the increment starting at t202.

Between time t202 and time t203, measuring curve CM is contained between S− and S+ in the various increments considered. Even though there is a portion of curve CM just before time t203 below threshold S−, the measurement is not less than threshold S− over the entire increment ending at t203. The setpoint is thus maintained in the next increment between t203 and t204.

Between time t203 and time t204, curve portion 204 is less than threshold S−−. Thus, the measurement in increment PRS− between t203 and t204 is less than threshold S−−. Therefore, the setpoint is reduced by a value greater than the steps of FIG. 4. The setpoint reduction is thus greater, which allows a more significant braking action to be obtained.

In FIG. 7, the torque reduction is such that the setpoint is deliberately set to zero, so as to perform an emergency stop. The setpoint is not determined by a predefined reduction value but, by definition, directly from the setpoint value to be applied in the next increment starting at time t204. Thus, a zero value is defined for the setpoint in the increment starting at time t204 to create an emergency stop. This setpoint is then maintained at a zero value over the rest of curve CM with the curve remaining, in the various increments after t204, contained between first threshold S− and second threshold S+. Stoppage is thus maintained.

1-19. (canceled)

20. A method of controlling a removable electric propulsion system for a rolling object, the propulsion system comprising at least one wheel driven by an electric machine, the control method comprising the steps of:
a) measuring at least one signal representative of the torque exerted by the rolling object on the propulsion system at the at least one driven wheel;
b) comparing the measured at least one signal with at least a first threshold and with at least a second threshold; and
c) controlling electric machine so that:
if the measurement is less than the first threshold for a first duration, a setpoint of the torque exerted by the electric machine on the driven wheel is decreased by a first predetermined value; and
if the measurement is greater than the second threshold for a second duration, the setpoint of the torque exerted by the electric machine on the driven wheel is increased by a second predetermined value.

21. A control method as claimed in claim 20, wherein, if in step c) measurement of the at least one signal ranges between the first threshold and the second threshold, a setpoint of the torque exerted by the electric machine on the driven wheel is maintained.

22. A control method as claimed in claim 21, wherein, if in step c) measurement of the at least one signal ranges between the first threshold and the second threshold, a setpoint of the torque exerted by the electric machine on the driven wheel is decreased by predefined increments until stopping.

23. A control method as claimed in claim 22, wherein, in step c), the setpoint is decreased using an energy dissipation device connected to the electric machine.

24. A control method as claimed in claim 20, wherein the first threshold is negative and the second threshold is positive.

25. A control method as claimed in claim 20, wherein the first duration is equal to the second duration.

26. A control method as claimed in claim 20, wherein the first predetermined value is equal to the second predetermined value.

27. A control method as claimed in claim 20, wherein the first predetermined value depends on a difference between the measured at least one signal and the first threshold.

28. A control method as claimed in claim 20, wherein the second predetermined value depends on a difference between the first measured signal and the second threshold.

29. A control method as claimed in claim 20, wherein if the measurement is less than a third threshold for a third duration so that at least one of the third threshold is less than the first threshold and the third duration is less than the first duration, the setpoint of the electric machine is decreased by a third predetermined value.

30. A control method as claimed in claim 20, wherein if the measurement is greater than a fourth threshold for a fourth duration, the fourth threshold is at least one of greater than the second threshold and the fourth duration being less than the second duration, the setpoint of the electric machine is modified by a fourth predetermined value greater than the second predetermined value.

31. A control method as claimed in claim 30, wherein the setpoint of the electric machine is increased by a fourth predetermined value.

32. A control method as claimed in claim 30, wherein the setpoint of the electric machine is decreased by a fourth predetermined value which prevents runaway of the propulsion system.

33. A control method as claimed in claim 20, wherein the measurement of the signal representative of the torque exerted by the rolling object on the propulsion system at the driven wheel is corrected, when measurement of the at least one signal representative of the torque ranges between the first threshold and the second threshold, prior to comparing the corrected measurement with the first and the second thresholds.

34. A removable electric propulsion system for a rolling object, comprising a chassis provided with at least one wheel driven by an electric machine, at least one non-driven wheel and a coupling for coupling the propulsion system to the rolling object, the coupling comprising means for gripping and lifting at least one wheel of the rolling object, wherein the propulsion system comprises means for measuring at least one signal representative of the torque exerted by the rolling object on the propulsion system at the at least one wheel driven by the electric machine and controlling the electric machine to implement the method of control as recited in claim 20.

35. A propulsion system as claimed in claim 34, wherein the coupler comprises means for orienting at least one wheel of the rolling object in a direction perpendicular to a longitudinal direction of the chassis of the propulsion system.

36. A propulsion system as claimed in claim 34, wherein at least one of driven wheels is an off-centered wheel which is orientable about a vertical axis, and the propulsion system comprises a controller of the electric machine which controls the electric machine depending on the measuring of the at least one signal representative of the torque.

37. A propulsion system as claimed in claim 34, wherein at least one of driven wheels is an off-centered wheel which is orientable about a vertical axis, and the propulsion system comprises a controller of the electric machine which controls the electric machine depending on the measurement of the at least one signal.

38. A coupled assembly comprising a rolling object and an electric propulsion system according to claim 34, wherein the rolling object is coupled to the electric propulsion system by the coupling.

39. A coupled assembly as claimed in claim 38, wherein the rolling object is one of a rolling bed, a trolley, rolling furniture or a wheelchair.
